(19) United States
(12) Patent Application Publication
(10) Pub. No.: US 2017/0084190 A1
(43) Pub. Date: Mar. 23, 2017

(54) Method for Efficiently Teaching Content Using an Adaptive Engine

(71) Applicant: BrainQuake Inc, Petaluma, CA (US)

(72) Inventor: Keith James Devlin, Petaluma, CA (US)

(21) Appl. No.: 15/369,699

(22) Filed: Dec. 5, 2016

Related U.S. Application Data
(63) Continuation-in-part of application No. 15/044,641, filed on Feb. 16, 2016.
Application No. 15/044,641 is a continuation-in-part of application No. 14/833,037, filed on Aug. 21, 2015.
Application No. 14/833,037 is a continuation-in-part of application No. 14/833,033, filed on Aug. 21, 2015.
(60) Provisional application No. 62/116,707, filed on Feb. 16, 2015.
(60) Provisional application No. 62/040,091, filed on Aug. 21, 2014.
(60) Provisional application No. 62/040,091, filed on Aug. 21, 2014.

(51) Int. Cl. G09B 7/04; G09B 5/02; G09B 19/02

(52) U.S. Cl. CPC G09B 7/04; G09B 19/025; G09B 5/02

(57) ABSTRACT

A teaching method and system which effectively and efficiently teaches content to a user. The method includes administering a series of teaching topics to the user through a personal computing (PC) device, where each topic includes a lead problem and a plurality of secondary problems. As the user solves the problems within each topic, the PC device monitors and analyzes the user's cognitive ability based on which solution was found for each of the problems. Subsequently, the PC device alters which problems are then offered to the user at each incremental step to reflect the user's performance on the previously problems. This is achieved by using open-ended problems with an optimal solution and an at least one other solution. If the optimal solution is identified, then the user can skip certain problems. If the other solution is identified, the user is simply moved to the next problem within the topic.

### FIELD OF THE INVENTION

The present invention relates generally to an education method using adaptive learning. More specifically, the present invention is a method for efficiently teaching content, educational content in particular, through the use of an adaptive engine. The adaptive engine continuously monitors a user performance in real-time in order to alter and tailor the content offered to the user based on his or her progressive knowledge and ability.

### BACKGROUND OF THE INVENTION

A major component of digitally implemented learning systems in mathematics (the field used in this application for illustrative purposes) is the regular provision of problems or puzzles that need to be solved to proceed. It is well established in mathematics education that to be most effective, problems or puzzles must be at the upper limit of a user's ability at that moment—within what is known as the user's zone of proximal development (ZPD). To achieve this aim, the system must constantly monitor the performance of the user to determine, dynamically, what the user's current ability level is, and to select problems or puzzles that keep the user in his or her ZPD. Since mathematical problems or puzzles can be developed on a linear scale of difficulty, doing this is straightforward, and has been implemented on many occasions in different systems. It can work well in a system that focuses on one particular skill or technique. However, for a learning system that covers a range of topics, there is a tension between ensuring curriculum coverage and maintaining the user in his or her ZPD.

Therefore, the present invention addresses this issue by resolving the tension. The present invention utilizes a unique structure of open-ended problems or puzzles in conjunction with an adaptive engine to keep the user in his or her ZPD while simultaneously ensuring curriculum coverage. Open-ended problems or puzzles are not multiple-choice questions; nor are they questions that have unique correct answers. Rather, such questions are what mathematics education experts refer to as complex performance tasks. Such problems contain a multitude of solutions, ranging from minimal adequacy to optimal. The present invention monitors a user's performance and ability while he or she addresses such type of problems to continuously modify and tailor a specific set of questions from each curriculum for the user.

### BRIEF DESCRIPTION OF THE DRAWINGS

FIG. 1 is a schematic diagram of the present invention.

FIG. 2 is a flowchart depicting the overall process of the present invention.

FIG. 3 is a flowchart depicting the overall process of the present invention.

FIG. 4 is a flowchart depicting steps necessary to execute if the answering data matches the other solution of the specific problem, within the overall process of the present invention.

FIG. 5 is a flowchart depicting steps necessary to execute if the answering data matches the optimal solution of the specific problem, within the overall process of the present invention.

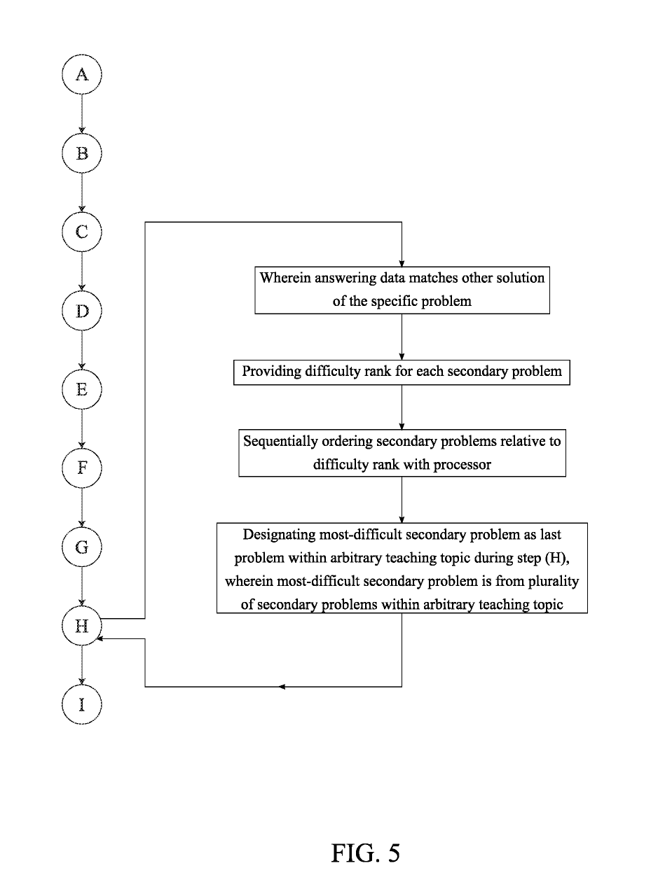

FIG. 6 is a flowchart depicting steps necessary to designate the arbitrary iteration as the last iteration with the processor, within the overall process of the present invention.

FIG. 7 is a flowchart depicting the steps necessary to designate the arbitrary iteration as the last iteration with the processor, within the overall process of the present invention.

FIG. 8 is a flowchart depicting the steps necessary to a previous iteration with the processor, within the overall process of the present invention.

FIG. 9 is a flowchart depicting the steps necessary to prompt to solve a series of assessment problems prior to initiating the overall process of the present invention.

FIG. 10 is a flowchart depicting the steps necessary to analyze the performance score for the series of assessment problems and place the user accordingly within the series of teaching topics, within the overall process of the present invention.

FIG. 11 is a flowchart depicting the conditions necessary to ensure adequate curriculum coverage for the user, within the overall process of the present invention.

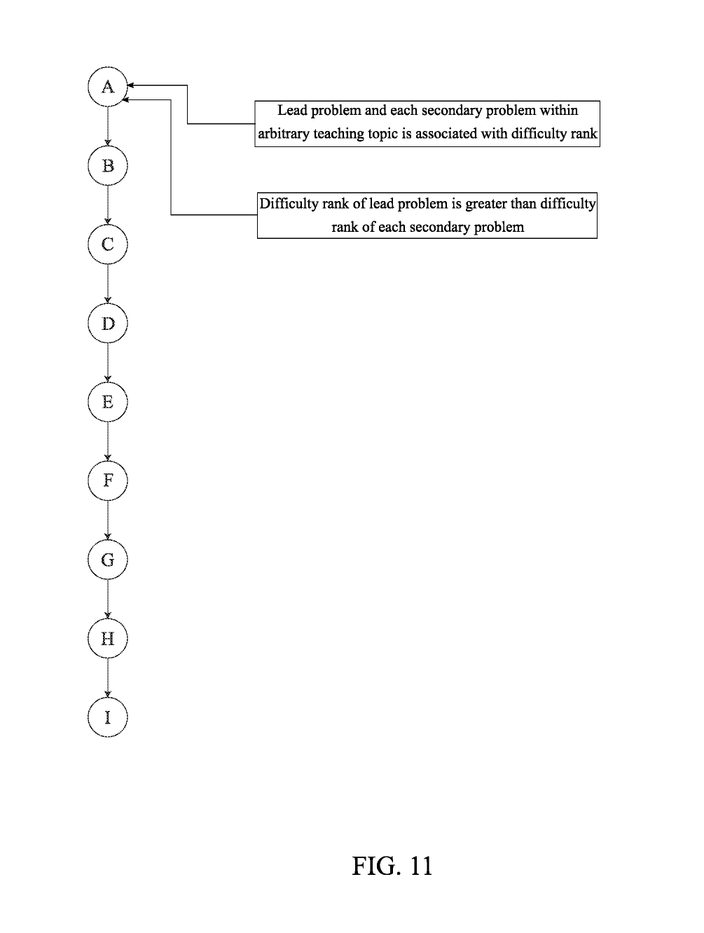

FIG. 12 is a flowchart depicting the execution of the entry module prior to the overall process of the present invention.

### DETAIL DESCRIPTIONS OF THE INVENTION

All illustrations of the drawings are for the purpose of describing selected versions of the present invention and are not intended to limit the scope of the present invention.

The present invention relates generally to the field of cognitive testing and adaptive learning. More specifically, the present invention is a method and system for effectively and efficiently teaching educational content using adaptive learning and open-ended problems or puzzles. The present invention monitors an individual's performance while he or she is solving a problem and utilizes adaptive learning to select following problems or puzzles of the requisite level of difficulty. This ensures that the individual is adequately challenged and is kept in his or her zone of proximal development (ZPD). At the same time, the present invention ensures adequate coverage of each offered curriculum by requiring the individual to solve a specific problem from each curriculum; which if solved, demonstrates high degree of proficiency. A variety of problems may be used for the present invention in order to suit the education level for each individual. The problems may be represented in the form of a puzzle or may be presented through a variety of mediums. The ideal problem is an open-ended problem that is presented to the individual in the form of a puzzle, a game essentially.

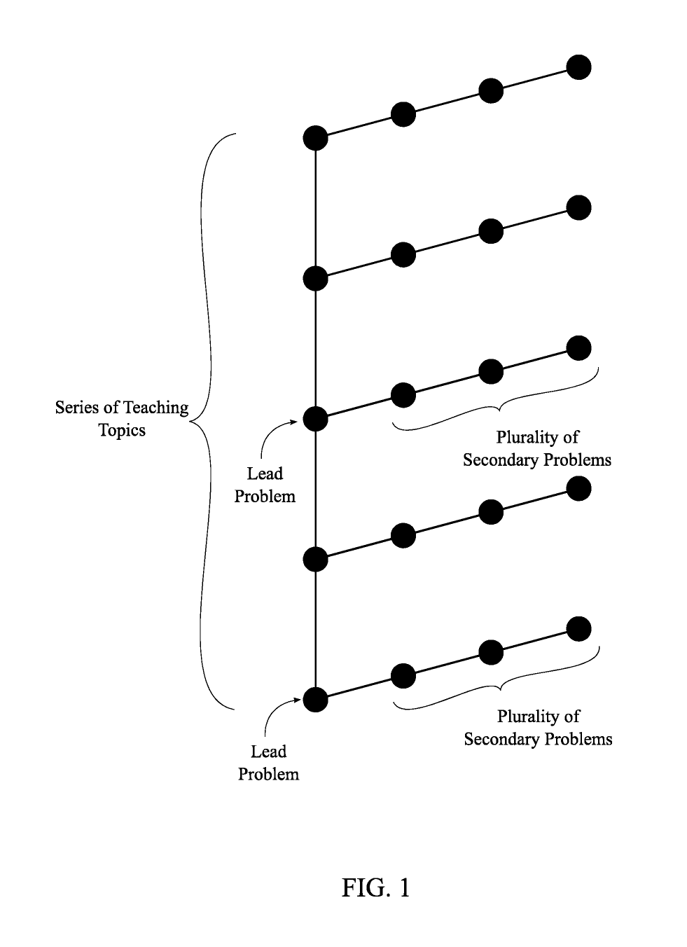

Referring to FIG. 1, the present invention includes a series of teaching topics, wherein each teaching topic includes a lead problem and a plurality of secondary problems (Step A). Each of the teaching topics is associated with a specific curriculum; a curriculum may be focused on a specific concept, puzzle type, theme, or a field of study. For example, one implementation of the present invention utilizes different mathematical concepts and problem-solving challenges in order to make up the series of teachings topics. The lead problem and secondary problems for each teaching topic all focus on the same curriculum. Each of the problems is an open-ended problem or puzzle and can be solved a multitude of ways, with each way being associated with an answer that is satisfactory according to a prescribed measure. More specifically, the lead problem and the secondary problems for each of the teaching topics each are associated with an optimal solution and an at least one other solution (Step B). The optimal solution may be defined based on the least number of steps used to solve the problem, the highest score attained in solving the problem according to a prescribed scoring system, the exact sequence of steps taken to solve the problem (“solution path”), and/or other similar characteristics. The other solution is any solution other than the optimal solution.

Referring to FIG. 1, in the preferred embodiment of the present invention, the series of teachings topics is organized in a tree-like structure, comprising a central trunk and a multitude of branches. The central trunk comprises the lead problems for each of the teaching topics arranged in a linear fashion. Each of the lead problems is further connected to an emanating branch. Each branch comprises the secondary problems associated with the teaching topic of the lead problem. The secondary problems and lead problem for each of the teaching topics is further associated with a difficulty rank that is used to incrementally increase the problem difficulty for the individual. In the preferred embodiment of the present invention, the difficulty rank of the lead problem is greater than the difficulty rank of each secondary problem within each of the teaching topics. Thus, the lead problem is used as a test for the associated teaching topic. If the individual can effectively solve the lead problem for a specific teaching topic, then he or she may skip the secondary problems of the specific teaching topic. This allows an individual that has a high level of proficiency to quickly progress through the series of teaching topics to a curriculum that adequately challenges him or her without having to repeat content which he or she has already matstered. This is one of the key points of the present invention.

The present invention comprises a method and a system. The method delineates the rules and steps necessary to construct a specific path for a user through the series of teaching topics. The specific path is based on the performance of the user and thus is modified after each addressed problem. The system comprises the physical components necessary to execute the method of the present invention. The system minimally comprises a personal computing (PC) device. The PC device includes a processor and a physical user interface (Step C). The processor executes the method of the present invention in the form of a software application. The physical user interface administers the series of teaching topics and allows the user to interact with the present invention to solve and transition through the series of teaching topics. Type of devices that may be used as the PC device include, but are not limited to, desktop computers, laptop computers, smartphones, tablets, and other similar electronic devices.

Two important aspects to note for the present invention: there are no multiple-choice questions and the user must carry out all key steps of the problem or puzzle with the PC device. This allows the present invention to monitor and track every step that the user goes through (“solution path”) in order to solve the problem or puzzle, thus providing raw descriptive information relating to the individual's cognitive/solving ability.

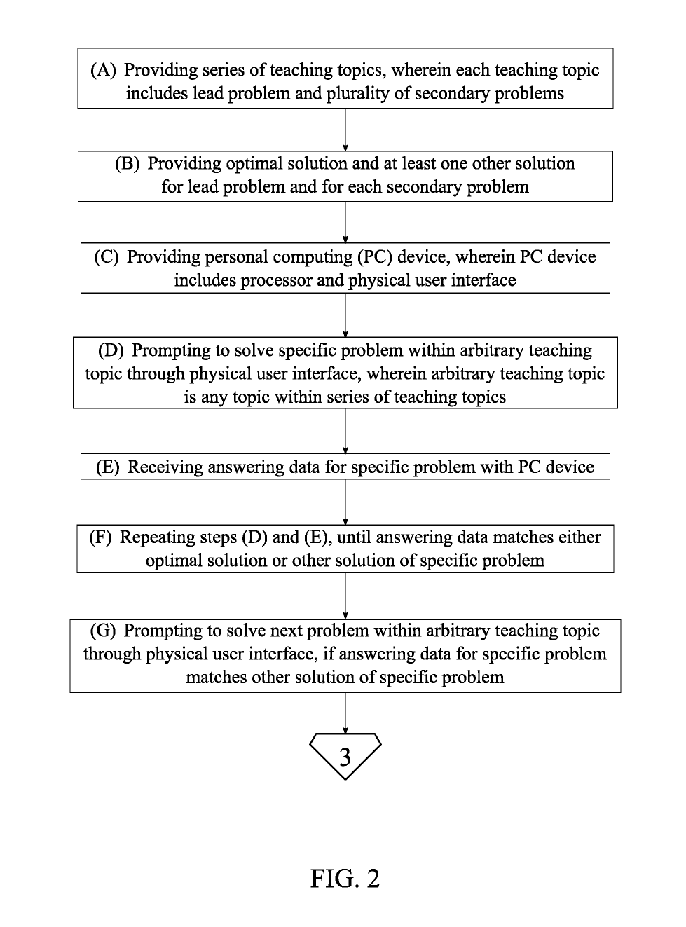

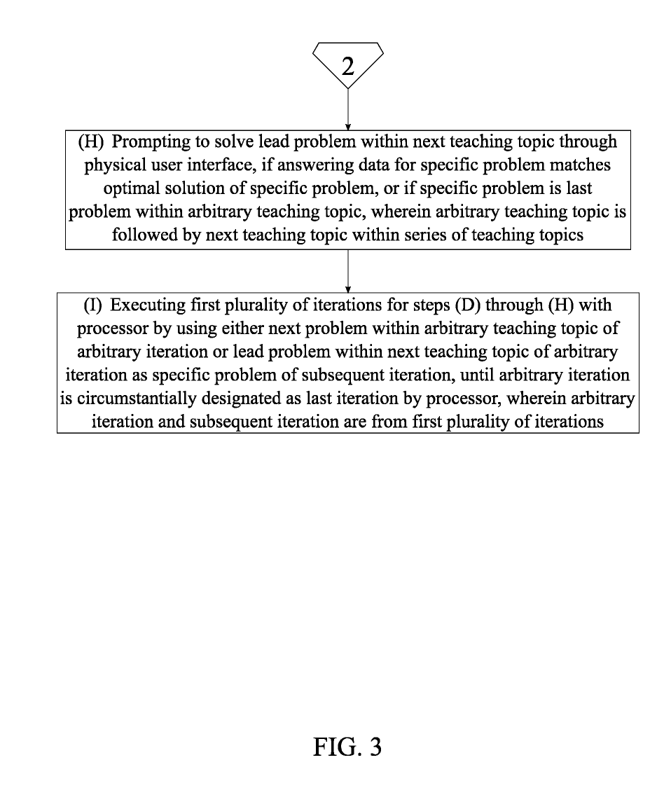

Referring to FIG. 2 and FIG. 3, the overall process of the present invention begins with the physical user interface prompting to solve a specific problem within an arbitrary teaching topic, wherein the arbitrary teaching topic can be any topic within the series of teaching topics (Step D). The user then attempts to solve the specific problem through the physical user interface. Answering data for the specific problem is received with the PC device (Step E) to be analyzed. If the answering data is not acceptable, then Steps D and E are repeated until the answering data matches either the optimal solution or the other solution of the specific problem. Once a solution for the specific problem is found, the user's performance is analyzed based on which solution was found and, resultantly, directed accordingly through the series of teaching topics.

If the answering data of the specific problem matches the other solution of the specific problem, then the user is directed to solve a next problem within the arbitrary teaching topic; the physical user interface prompts to solve the next problem within the arbitrary teaching topic (Step G). The other solution for the specific solution indicates average proficiency in the curriculum of the arbitrary teaching topic. In which case, the user is directed to solve the secondary problems from the arbitrary teaching topic in order to practice, achieve mastery, and ensure curriculum coverage before progressing to the next curriculum, i.e. the next teaching topic following the arbitrary teaching topic. In other words, this conditional moves the user through the branch of the arbitrary teaching topic one problem at a time if any solution besides the optimal solution is entered.

Alternatively, if the answering data of the specific problem matches the optimal solution of the specific problem, then the user is prompted to solve the lead problem within a next teaching topic through the physical user interface (Step H). The next teaching topic is defined as the teaching topic following the arbitrary teaching topic within the series of teachings topics. In general, identifying the optimal solution for the specific problem signifies that the user has the required degree of solution proficiency for the curriculum associated to the arbitrary teaching topic. Thus, the user is permitted to skip the rest of the problems within the arbitrary teaching topic and jump to the next point in the trunk. This condition endures that the user is kept within his or her ZPD at each step within the series of teaching topics.

Additionally, during Step H, if the specific problem is a last problem within the arbitrary teaching topic, then the user is prompted to solve the lead problem within the next teaching topic, regardless whether the answering data for the specific problem matches the optimal solution or the other solution of the specific problem. Reaching and solving the last problem within the arbitrary teaching topic indicates that the user has reached an acceptable proficiency for the curriculum associated with the arbitrary teaching topic and is thus permitted to move on to the next teaching topic.

Finally, the last step in the overall process of the present invention is executing the aforementioned steps for the series of teaching topics. In particular, executing a first plurality of iterations for Steps D through H with the processor by using either the next problem within the arbitrary teaching topic of an arbitrary iteration or the lead problem within the next teaching topic of the arbitrary iteration as the specific problem of a subsequent iteration (Step I). This is executed until the arbitrary iteration is circumstantially designated as a last iteration by the processor. The arbitrary iteration and the subsequent iteration are from the first plurality of iterations. Each of the first iterations is Step D through H being executed for a particular problem; the particular problem is dependent on the user's real-time performance and knowledge/proficiency of the curriculum being addressed.

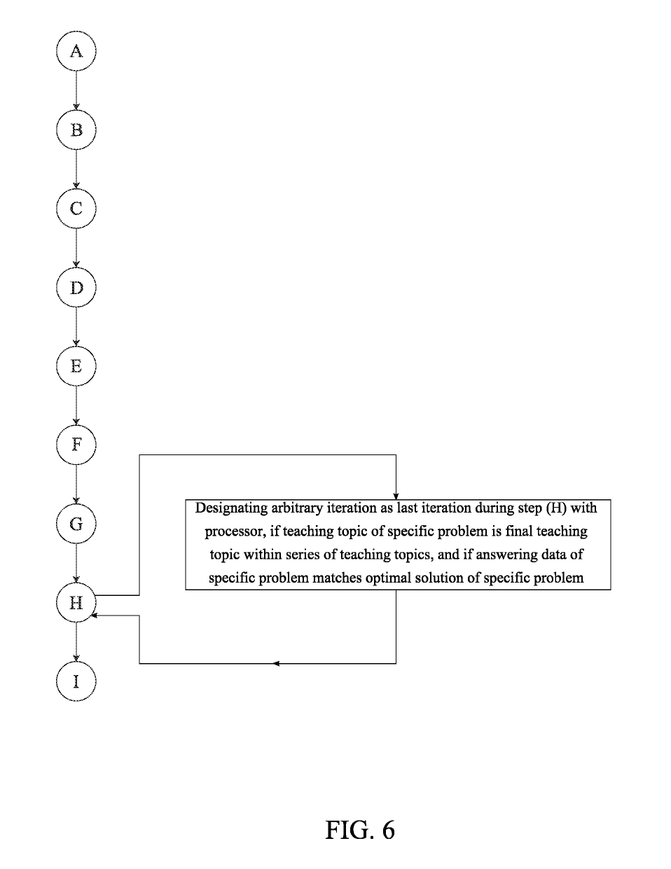

The overall process of the present invention is executed until the user demonstrates adequate proficiency in every teaching topic. In relation to the overall process, this is the case when the arbitrary iteration is designated as the last iteration. One such instance is when the user shows adequate proficiency in a final teaching topic by solving one of the problems from the final teaching topic with the optimal solution of said problem; wherein the final teaching topic is the last topic within the series of teaching topics. Referring to FIG. 6, the user is finished if the following conditions are met: (1) the teaching topic of the specific problem is the final teaching topic; and (2) the answering data for the specific problem matches the optimal solution of the specific problem. If these conditions are met, then the arbitrary iteration is designated as the last iteration during Step H with the processor. Thus, indicating that the user has master the curriculum of the final teaching topic and, resultantly, has finished the series of teaching topics.

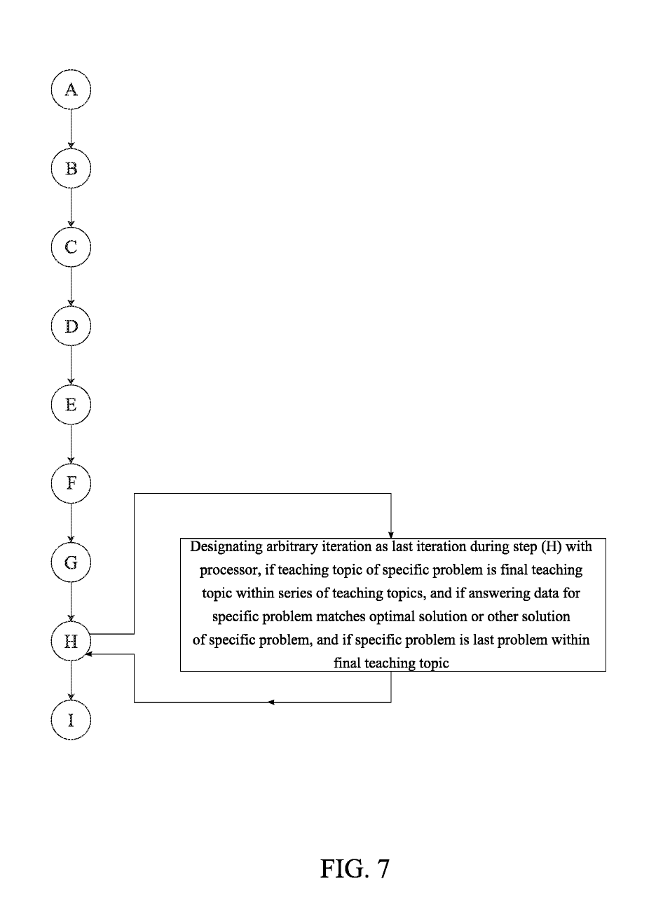

Another instance is when the user has reached and solved a last problem within the final teaching topic. Referring to FIG. 7, in relation to the overall process, the user is finished if the following conditions are met: (1) the teaching topic of the specific problem is the final teaching topic; (2) the answering data for the specific problem matches either the optimal solution or the other solution of the specific problem; and (3) the specific problem is the last problem within the final teaching topic. If these conditions are met, then the arbitrary iteration is designated as the last iteration during Step H by the processor, and the user finishes the series of teaching topics.

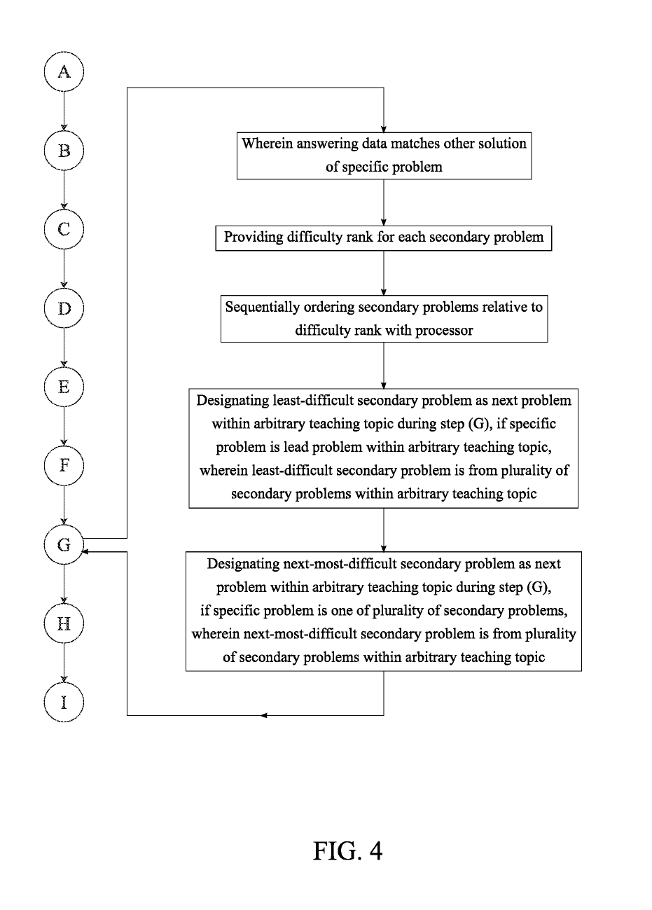

Referring to FIG. 4, if the user finds the other solution for the specific problem, then he or she may be directed onto two different paths. The determining factor is if the specific problem is either the lead problem or the one of the secondary problems. Prior to directing the user, the processor first sequentially orders the secondary problems relative to the difficulty rank such that the user is incrementally exposed to harder and harder problems. If the specific problem is the lead problem, then the user is directed to solve the secondary problems within the arbitrary teaching topic. More specifically, a least-difficult secondary problem is chosen and designated as the next problem within the arbitrary teaching topic during Step G, wherein the least-difficult secondary problem is from the plurality of secondary problems within the arbitrary teaching topic.

Alternatively, if the specific problem is one of the plurality of secondary problems, then the user is directed to solve the problem after the specific problem within the arbitrary teaching topic. In particular, a next-most-difficult secondary problem is designated as the next problem within the arbitrary teaching topic during Step G. The next-most-difficult secondary problem is from the plurality of secondary problems within the arbitrary teaching topic. Furthermore, it is important to note that the last problem referenced in Step H is the final problem within the arbitrary teaching topic. More specifically, a most-difficult secondary problem is designated as the last problem during Step H; wherein the most-difficult secondary problem is from the plurality of secondary problems within the arbitrary teaching topic. The final problem is the most difficult in order to test the user in the curriculum of the arbitrary teaching topic.

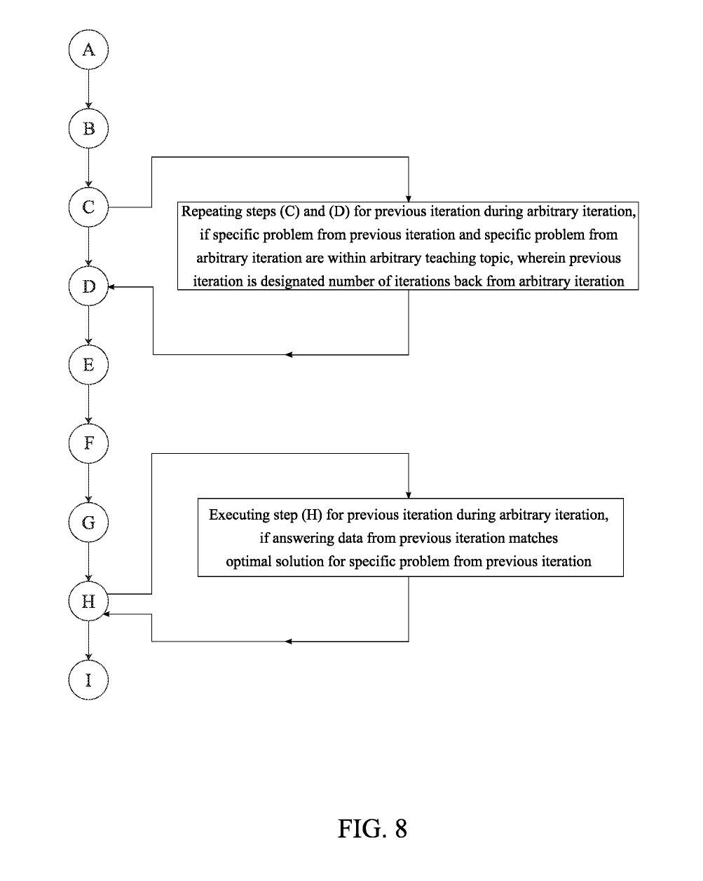

Referring to FIG. 8, anytime during the overall process of the present invention the user is able to return to previously addressed problems and attempt to find a different solution, in particular the optimal solution. In relation to the overall process, step C and step D may be repeated for a previous iteration during the arbitrary iteration, if the specific problem from the previous iteration and the specific problem from the arbitrary iteration are within the arbitrary teaching topic, wherein the previous iteration is a designated number of iterations back from the arbitrary iteration. The designated number of iterations is set by an administrator account. Any problems further back than the designated number of iterations will not award the user with the ability to skip to the next teaching topic if he or she identifies the optimal solution. In alternative embodiments of the present invention, the user may cross to previous topics in order to repeat problems. If the user matches the answering data from the previous iteration to the optimal solution for the specific problem from the previous iteration, then the system executes step H for the previous iteration during the arbitrary iteration.

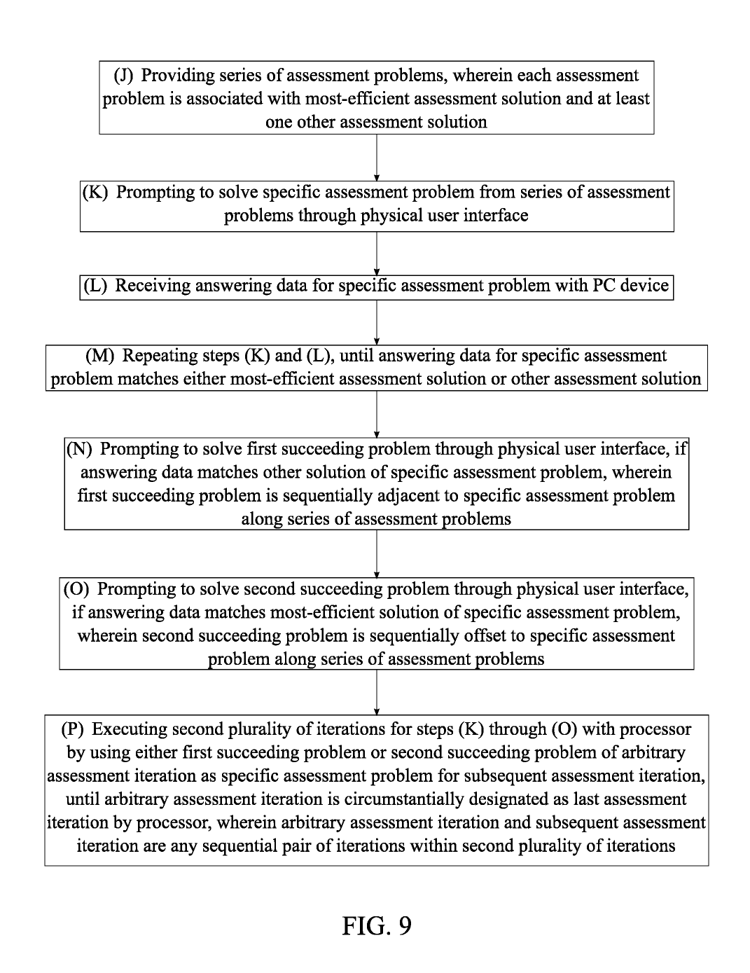

Referring to FIG. 9, prior to allowing the user to solve the series of teachings topics, the present invention first requires the user to pass through an entry module. The entry module provides a rapid assessment of the user's ability and proficiency regarding the curriculums within the series of teaching topics. The results from the entry module are used to place the user within the series of teaching topics accordingly. For example, weak users are placed at an initial topic from the series of teaching topics while stronger users may be allowed to skip a number of early topics.

The entry module includes a series of assessment problems, wherein each assessment problem is associated with an optimal assessment solution and an at least one other assessment solution, similar to the overall process (Step J). The series of assessment problems is populated with questions, problems, or puzzles of different curriculums, thus allowing the system to fully determine the user's abilities. Additionally, the assessment problems may be easier than the problems from the series of teaching topics. The process for the entry module is similar to the overall process of the present invention. First, the user is prompted to solve a specific assessment problem from the series of assessment problems through the physical user interface (Step K). Next, the user solves the specific assessment problem through the user interface. The system receives answering data for the specific assessment problem with the PC device (Step L). Steps K and L are repeated until the answering data for the specific assessment problem matches either the optimal assessment solution or the other assessment solution of the specific assessment problem. The user's path through the assessment problems is partially adaptive, i.e. the path is dependent on the user's performance.

If the answering data matches the other assessment solution of the specific assessment problem, then the user is incrementally moved to the next problem within the series of assessment problems. In particular, the user is prompted to solve a first succeeding problem through the physical user interface, wherein the first succeeding problem is sequentially adjacent to the specific assessment problem along the series of assessment problems (Step N). This is similar to the overall process.

If the answering data matches the optimal assessment solution of the specific assessment problem, then the user is moved forward through the series of assessment problems a pre-set number of steps. In particular, the user is prompted to solve a second succeeding problem through the physical user interface, wherein the second succeeding problem is sequentially offset to the specific assessment problem along the series of assessment problems (Step O). The offset, the number of steps, may vary depending on the specific assessment problem, the type of educational content, type of problems, or type of puzzles used for the present invention.

The user is maintained within the entry module until he or she reaches and solves a final problem within the series of assessment problems. More specifically, the processor executes a second plurality of iterations for Steps K through O by using either the first succeeding problem or the second succeeding problem of an arbitrary assessment iteration as the specific assessment problem for a subsequent assessment iteration. The second plurality of iterations is executed until the arbitrary assessment iteration is circumstantially designated as a last assessment iteration by the processor. The arbitrary assessment iteration and the subsequent assessment iteration are any sequential pair of iterations within the second plurality of iterations.

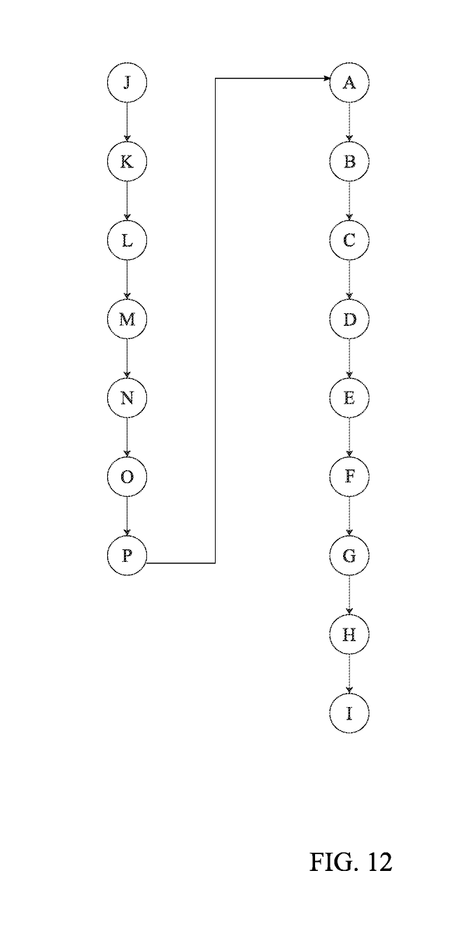

Referring to FIG. 12, the present invention utilizes performance data from the entry model to determine where in the series of teaching topics the user should be placed. In order to achieve this, performance criteria are provided for each of the teaching topics. The performance criteria quantify a minimum proficiency/ability necessary to solve problems within the associated teaching topic. Once the user completes the entry module, the processor assesses a performance score for each of the second plurality of iterations. A variety of scoring methods may be used for determining the performance score. Then, the performance score for each of the second plurality of iterations is compiled into an overall performance score with the processor. The overall performance score is then compared to the performance criteria for each teaching topic with the processor in order to identify a set of matching topics from the series of teaching topics. The set of matching topics is the teaching topics within the series of teaching topics which the user has shown proficiency in and therefore does not need to solve. This ensures that the problems addressed by the user in the overall process of the present invention are within his or her ZPD.

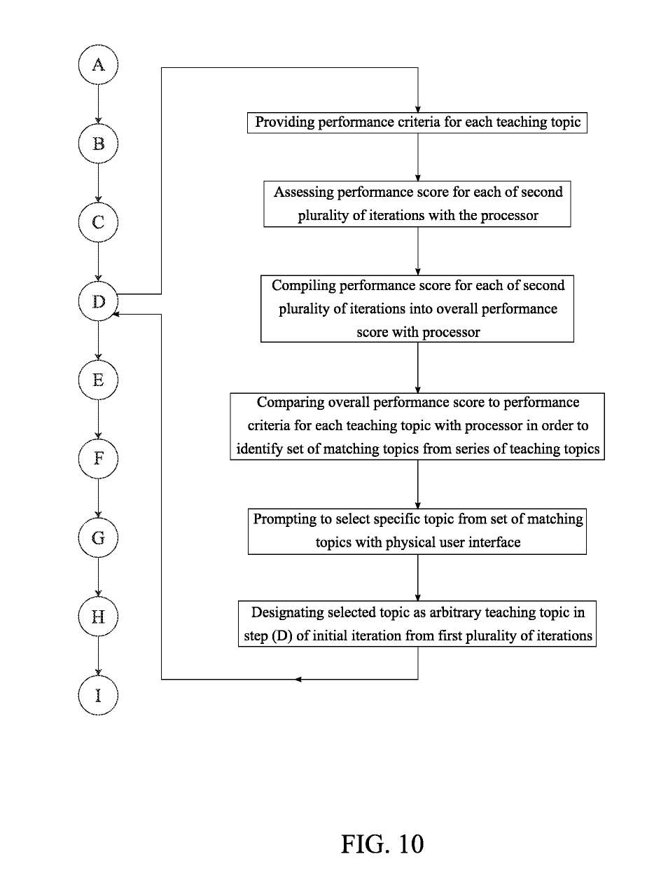

Once identified, the set of matching topics is then displayed to the user for selection. Referring to FIG. 10, the physical user interface prompts the user to select a specific topic from the set of matching topics. Once chosen, the selected topic is designated as the arbitrary teaching topic in Step D of an initial iteration from the first plurality of iterations. This process assesses the user's ability and places him or her accordingly within the series of teaching topics.

In one embodiment, the present invention also includes a basics module, essentially a training area. If at any point the system identifies that the user is struggling to solve a problem, then he or she is directed towards the basics module. In one embodiment, certain problems within the entry module are dedicated to separating users with strong and weak abilities. The basics module tutors the user through basic elements utilized in the problems within the series of assessment problems and the series of teaching topics. In order for the user to exit the basics module, the user must complete all the problems and tasks within the basics module. Although, there is a one-time exit opportunity, if the user solves the first predetermined number of problems within the basics module by finding the optimal solution in a single try for each one, then the user may exit the basic module.

Although the invention has been explained in relation to its preferred embodiment, it is to be understood that many other possible modifications and variations can be made without departing from the spirit and scope of the invention as hereinafter claimed.

What is claimed is:

1. A method for efficiently teaching content using an adaptive engine comprises the steps of:
(A) providing a series of teaching topics, wherein each teaching topic includes a lead problem and a plurality of secondary problems;
(B) providing an optimal solution and an at least one other solution for the lead problem and for each secondary problem;
(C) providing a personal computing (PC) device, wherein the PC device includes a processor and a physical user interface;
(D) prompting to solve a specific problem within an arbitrary teaching topic through the physical user interface, wherein the arbitrary teaching topic is any topic within the series of teaching topics;
(E) receiving answering data for the specific problem with the PC device;
(F) repeating steps (D) and (E), until the answering data matches either the optimal solution or the other solution of the specific problem;
(G) prompting to solve a next problem within the arbitrary teaching topic through the physical user interface, if the answering data for the specific problem matches the other solution of the specific problem;
(H) prompting to solve the lead problem within a next teaching topic through the physical user interface, if the answering data for the specific problem matches the optimal solution of the specific problem, or if the specific problem is a last problem within the arbitrary teaching topic, wherein the arbitrary teaching topic is followed by the next teaching topic within the series of teaching topics; and
(I) executing a first plurality of iterations for steps (D) through (H) with the processor by using either the next problem within the arbitrary teaching topic of an arbitrary iteration or the lead problem within the next teaching topic of the arbitrary iteration as the specific problem of a subsequent iteration, until the arbitrary iteration is circumstantially designated as a last iteration by the processor, wherein the arbitrary iteration and the subsequent iteration are from the first plurality of iterations.

2. The method for efficiently teaching content using an adaptive engine as claimed in claim 1 comprises the steps of:
wherein the answering data matches the other solution of the specific problem;
providing a difficulty rank for each secondary problem;
sequentially ordering the secondary problems relative to the difficulty rank with the processor;
designating a least-difficult secondary problem as the next problem within the arbitrary teaching topic during step (G),
if the specific problem is the lead problem within the arbitrary teaching topic,
wherein the least-difficult secondary problem is from the plurality of secondary problems within the arbitrary teaching topic; and
designating a next-most-difficult secondary problem as the next problem within the arbitrary teaching topic during step (G),
if the specific problem is one of the plurality of secondary problems,
wherein the next-most-difficult secondary problem is from the plurality of secondary problems within the arbitrary teaching topic.

3. The method for efficiently teaching content using an adaptive engine as claimed in claim 1 comprises the steps of:
wherein the answering data matches the other solution of the specific problem;
providing a difficulty rank for each secondary problem;
sequentially ordering the secondary problems relative to the difficulty rank with the processor; and
designating a most-difficult secondary problem as the last problem within the arbitrary teaching topic during step (H), wherein the most-difficult secondary problem is from the plurality of secondary problems within the arbitrary teaching topic.

4. The method for efficiently teaching content using an adaptive engine as claimed in claim 1 comprises the steps of:
designating the arbitrary iteration as the last iteration during step (H) with the processor,
if the teaching topic of the specific problem is a final teaching topic within the series of teaching topics,
and if the answering data of the specific problem matches the optimal solution of the specific problem.

5. The method for efficiently teaching content using an adaptive engine as claimed in claim 1 comprises the steps of:
designating the arbitrary iteration as the last iteration during step (H) with the processor,
if the teaching topic of the specific problem is a final teaching topic within the series of teaching topics,
and if the answering data for the specific problem matches the optimal solution or the other solution of the specific problem,
and if the specific problem is a last problem within the final teaching topic.

6. The method for efficiently teaching content using an adaptive engine as claimed in claim 1 comprises the steps of:
repeating steps (C) and (D) for a previous iteration during the arbitrary iteration,
if the specific problem from the previous iteration and the specific problem from the arbitrary iteration are within the arbitrary teaching topic,
wherein the previous iteration is a designated number of iterations back from the arbitrary iteration; and
executing step (H) for the previous iteration during the arbitrary iteration,
if the answering data from the previous iteration matches the optimal solution for the specific problem from the previous iteration.

7. The method for efficiently teaching content using an adaptive engine as claimed in claim 1 comprises the steps of:
(J) providing a series of assessment problems, wherein each assessment problem is associated with an optimal assessment solution and an at least one other assessment solution;
(K) prompting to solve a specific assessment problem from the series of assessment problems through the physical user interface;
(L) receiving answering data for the specific assessment problem with the PC device;
(M) repeating steps (K) and (L), until the answering data for the specific assessment problem matches either the optimal assessment solution or the other assessment solution;
(N) prompting to solve a first succeeding problem through the physical user interface, if the answering data matches the other solution of the specific assessment problem, wherein the first succeeding problem is sequentially adjacent to the specific assessment problem along the series of assessment problems;
(O) prompting to solve a second succeeding problem through the physical user interface, if the answering data matches the optimal assessment solution of the specific assessment problem, wherein the second succeeding problem is sequentially offset to the specific assessment problem along the series of assessment problems; and
(P) executing a second plurality of iterations for steps (K) through (O) with the processor by using either the first succeeding problem or the second succeeding problem of an arbitrary assessment iteration as the specific assessment problem for a subsequent assessment iteration, until the arbitrary assessment iteration is circumstantially designated as a last assessment iteration by the processor, wherein the arbitrary assessment iteration and the subsequent assessment iteration are any sequential pair of iterations within the second plurality of iterations.

8. The method for efficiently teaching content using an adaptive engine as claimed in claim 7 comprises the steps of:
providing performance criteria for each teaching topic;
assessing a performance score for each of the second plurality of iterations with the processor;
compiling the performance score for each of the second plurality of iterations into an overall performance score with the processor;
comparing the overall performance score to the performance criteria for each teaching topic with the processor in order to identify a set of matching topics from the series of teaching topics;
prompting to select a specific topic from the set of matching topics with the physical user interface; and
designating the selected topic as the arbitrary teaching topic in step (D) of an initial iteration from the first plurality of iterations.

9. The method for efficiently teaching content using an adaptive engine as claimed in claim 1, wherein:
the lead problem and each secondary problem within the arbitrary teaching topic is associated with a difficulty rank; and
the difficulty rank of the lead problem is greater than the difficulty rank of each secondary problem.
